(19) United States
(12) Patent Application Publication
(10) Pub. No.: US 2020/0266457 A1
(43) Pub. Date: Aug. 20, 2020

(54) MULTIPOINT ELECTROLYTE FLOW FIELD EMBODIMENT FOR VANADIUM REDOX FLOW BATTERY

(71) Applicants: Angelo D'Anzi, Medicina (BO) (IT); Maurizio Tappi, Cesena (IT); Gianluca Piraccini, Cesena (IT); Carlo Alberto Brovero, Alexandria, VA (US)

(72) Inventors: Angelo D'Anzi, Medicina (BO) (IT); Maurizio Tappi, Cesena (IT); Gianluca Piraccini, Cesena (IT); Carlo Alberto Brovero, Alexandria, VA (US)

(21) Appl. No.: 16/498,399

(22) PCT Filed: Mar. 27, 2018
(86) PCT No.: PCT/US18/24414

§ 371 Date: Sep. 27, 2019

Related U.S. Application Data
(60) Provisional application No. 62/476,945, filed on Mar. 27, 2017.

(51) Int. Cl. H01M 8/0258; H01M 8/18; H01M 8/0213

(52) U.S. Cl. CPC H01M 8/0258; H01M 2008/1095; H01M 8/0213; H01M 8/188

(57) ABSTRACT

A flow battery of the type comprising a first tank for an anode electrolyte, a second tank for a cathode electrolyte, respective hydraulic circuits provided with corresponding pumps for supplying electrolytes to specific planar cells, provided with bipolar plates having multipoint flow distributors on the two mutually opposite faces for the homogenous conveyance of said electrolytes, mutually separated by proton exchange membranes and electrodes, wherein said planar cells are mutually aligned and stacked so as to constitute a flow battery stack.

### CROSS REFERENCE TO RELATED APPLICATIONS

This application claims the priority of Provisional Application No. 62/476,945 filed on Mar. 27, 2017. The entire disclosure of this provisional patent application is hereby incorporated by reference thereto, in its entirety.

### STATEMENT REGARDING FEDERALLY SPONSORED RESEARCH OR DEVELOPMENT

Not applicable.

### FIELD OF THE INVENTION

The present invention relates to a Bipolar plate structure of a vanadium redox flow battery, and particularly to a Bipolar Plate structure of a vanadium redox flow battery in which the graphite porous electrodes are interfaced to the multipoint flow distributor unit embedded in the in-out flow channels of graphite bipolar plates.

### BACKGROUND OF THE INVENTION

A flow battery is a type of rechargeable battery in which electrolytes that contain one or more dissolved electro-active substances flow through an electrochemical cell, which converts the chemical energy directly into electric energy. The electrolytes are stored in external tanks and are pumped through the cells of the reactor.

Redox flow batteries have the advantage of having a flexible layout (due to the separation between the power components and the energy components), a long life cycle, rapid response times, no need to smooth the charge and no harmful emissions.

Flow batteries are used for stationary applications with an energy demand between 1 kWh and several MWh: they are used to smooth the load of the grid, where the battery is used to accumulate during the night energy at low cost and return it to the grid when it is more expensive, but also to accumulate power from renewable sources such as solar energy and wind power, to then provide it during peak periods of energy demand.

In particular, a vanadium Redox battery consists of a set of electrochemical cells in which the two electrolytes are separated by a proton exchange membrane. Both electrolytes are based on vanadium: the electrolyte in the positive half-cell contains V<4+> and V<5+> ions while the electrolyte in the negative half-cell contains V<3+> and V<2+> ions. The electrolytes can be prepared in several ways, for example by electrolytic dissolution of vanadium pentoxide (V2O5) in sulfuric acid (H2SO4). The solution that is used remains strongly acidic. In vanadium flow batteries, the two half-cells are furthermore connected to storage tanks that contain a very large volume of electrolyte, which is made to circulate through the cell by means of pumps. Such circulation of liquid electrolytes requires a certain space occupation and limits the possibility to use vanadium flow batteries in mobile applications, in practice confining them to large fixed installations.

While the battery is being charged, in the positive half-cell the vanadium is oxidized, converting V<4+> into V<5+>. The acquired electrons are transferred the negative half-cell, where they reduce the vanadium from V<3+> to V<2+>. During operation, the process occurs in reverse and one obtains a potential difference of 1.41V at 25° C. in an open circuit.

The vanadium Redox battery is the only battery that accumulates electric energy in the electrolyte and not on the plates or electrodes, as occurs commonly in all other battery technologies.

Differently from all other batteries, in the vanadium Redox battery the electrolyte contained in the tanks, once charged, is not subjected to auto-discharge, while the portion of electrolyte that is stationary within the electrochemical cell is subject to auto-discharge over time.

The quantity of electric energy stored in the battery is determined by the volume of electrolyte contained in the tanks.

According to a particularly efficient specific constructive solution, a vanadium Redox battery consists of a set of electrochemical cells within which the two electrolytes, mutually separated by a polymeric electrolyte, flow. Both electrolytes are constituted by an acidic solution of dissolved vanadium. The positive electrolyte contains V<5+> and V<4+> ions, while the negative one contains V<2+> and V<3+> ions. While the battery is being charged, in the positive half-cell the vanadium oxidizes, while in the negatives half-cell the vanadium is reduced. During the discharge step, the process is reversed. The connection of multiple cells in an electrical series allows to increase the voltage across the battery, which is equal to the number of cells multiplied by 1.41 V.

During the charging phase, in order to store energy, the pumps are turned on, making the electrolyte flow within the electrochemical related cell. The electric energy applied to the electrochemical cell facilitates proton exchange by means of the membrane, charging the battery.

During the discharge phase, the pumps are turned on, making the electrolyte flow inside the electrochemical cell, creating a positive pressure in the related cell thus releasing the accumulated energy.

During the operation of the battery, the electrolyte flows linearly through the thickness of the porous electrodes from the bottom to the top providing charge transfer.

### Description of the Related Art

FIG. 1 is a schematic view showing a conventional vanadium redox flow battery. As shown in FIG. 1, the conventional vanadium redox flow battery includes a plurality of positive electrodes 7, a plurality of negative electrodes 8, a positive electrolyte 1, a negative electrolyte 2, a positive electrolyte tank 3, and a negative electrolyte tank 4. The positive electrolyte 1 and the negative electrolyte 2 are respectively stored in tank 3 and tank 4. At the same time, the positive electrolyte 1 and the negative electrolyte 2 respectively pass through the positive electrode 7 and the negative electrode 8 via the positive connection pipelines and the negative connection pipelines to form the respective loops also indicated in FIG. 1 with the arrows.

Pump 5 and pump 6 are often installed on the connection pipelines for continuously transporting the electrolytes to the electrode. Moreover, a power conversion unit 11, e.g. a DC/AC converter, can be used in a vanadium redox flow battery, and the power conversion unit 11 is respectively electrically connected to the positive electrode 7 and the negative electrode 8 via the positive connection lines 9 and the negative connection lines 10, and the power conversion unit 11 also can be respectively electrically connected to an external input power source 12 and an external load 13 in order to convert the AC power generated by the external input power source 12 to DC power for charging the vanadium redox flow battery, or convert the DC power discharged by the vanadium redox flow battery to AC power for outputting to the external load 13.

FIG. 2 is a schematic axonometric view of a conventional flow battery Stack according to the state of the art. That includes two opposite end plates 16, a plurality of gaskets 14, a plurality of positive electrodes 15, a plurality of negative electrodes 18, a plurality of bipolar plates 19 in which the flow fields 20 are embedded, and a series of membranes with protonic exchange 17.

As described in FIG. 3, electrolytes 22 respectively flow through the electrodes 15 and 18 via the flow field regions 20 (shown in FIG. 2) that correspond to the regions 22a, 22b, and 22c (shown in FIG. 3) connected to the positive and negative connection holes located in the bipolar plate 19 to form the regions shown schematically in FIG. 3 by the wavy lines. The flow direction is indicated by an arrow at an inlet flow 21 and by an outlet flow 23. The inlet and outlet flows occur through openings (unnumbered), such there is a pair of inlet openings and a pair of outlet openings. The schematically shown inlet flow would occur through both inlet openings (i.e. the pair on the same side as inlet flow 21) and would occur through both outlet openings (i.e. the pair on the same side as the outlet flow 23.

However, the disadvantages of the above-mentioned conventional flow battery include the concentration of the polarization of the electrolyte, which would cause the decrease of efficiency of the electron transfer in a battery so that the energy efficiency is decreased. As shown in FIG. 3 the electrolyte flow 22 that passes linearly through the thickness of the positive electrode 15 and the negative electrode 18, during said linear flow a charge transfer occurs thus creating a wide difference in polarization on the active area as described in FIG. 6 using shaded bands 88, 90, 92, 94, 96, and 98 to schematically denote the phenomena of concentration of the polarization.

FIG. 4 is a schematic axonometric view of a conventional electrode (15, 18) according to the state of the art, and is typical of an interdigital flow field. This is an improvement over the flow through type shown in FIG. 6, the interdigital flow field type having a power density which is roughly 3 times that of the flow through type. Here, an inlet flow direction D is shown along with an exit flow direction F. This results in a polarization that progressively increases, as shown schematically by bands 78, 80, 82, 84, 86, and 88. This is to show a gradual increase in polarization. FIG. 6 is a schematic axonometric view of an additional conventional electrode according to the state of the art, likewise having an inlet flow direction D and an exit flow direction F.

In both FIG. 4 and FIG. 6, the clear portion (flow In) of the electrode is the area where the polarization is negligible, while the dark area is the portion where the polarization is concentrated (flow Out). In other words, the clear portion of the electrode is not fully exploited due to the dark portion where the polarizations have reached the limit. The ideal conditions occur when all the portions of the electrode have polarizations (which corresponds to voltage) that are homogenous and this happens only when it is possible to supply electrolyte with the same voltage across the electrode surfaces.

The present invention ensures that there is a substantially homogeneous feed of electrolyte on the surface, thereby exploiting all the electrode portions at substantially nearly the maximum performance possible due to the short distance between flow in and flow out that does not allow the electrolyte to overcharge. The meaning of FIG. 4 and FIG. 6 is to show the results of an electrochemical reaction schematically, and specifically these figures schematically show the electrical polarizations on the electrode surface. The polarization is basically an overvoltage due to the internal resistance and in the case of a flow battery mainly due to the electrolyte diffusion on the electrode, wherein in some cases a slow electrolyte flow or even a stagnation causes localized critical overvoltages, i.e. polarizations. In the state of the art, the electrolyte flowing through the electrode during the pathway will receive charges so that the final portion of the electrode is fed by an electrolyte which has a higher voltage with respect to the input, and this over-voltage is really close to the maximum voltage permissible for a vanadium flow battery. This is limiting to the power.

FIG. 5 shows an additional interdigital flow field design according to the state of the art in which in the bipolar plate 19 has two dead end channels which are embedded therein and which force the electrolyte flow 24 to flow across the thickness of the positive electrode 15 and the negative electrode 18 transversely as indicated by the flow line paths shown. Here, the flow field region 24 is shown having bands 24a, 24b, and 24c. Also in this case, during the linear flow of the electrolyte inside the channels before passing through the electrodes, as the electrolyte is touching the electrodes a charge transfer occurs, creating in any case a difference in polarization on the active area as described in FIG. 4. A series of shaded bands are shown for describing the phenomena.

Therefore, there is a need for providing a vanadium redox flow battery in which the electrodes are fed homogeneously in order to solve the problems presented by the conventional flow battery designs described above, to achieve an efficient charge transfer so that the electric current density can be increased, and the energy efficiency can be improved, reducing the operating pressure of the electrolytes.

### SUMMARY OF THE INVENTION

Accordingly, the objective of the present invention is to provide a vanadium redox flow battery stack, having an innovative bipolar plate design which comprises: at least two end plates; at least one proton exchange membrane; at least two porous electrodes sandwiching the proton exchange membrane between them; a plurality of gaskets; at least one bipolar plate having a dead end flow field channel on both sides; at least two multipoint flow distributors having a plurality of holes. Said multipoint distributor is placed on top of the bipolar plate in correspondence to the flow fields in such a manner that the plurality of holes are aligned to the inlet and outlet flow channels; a positive electrode and a negative electrode are being placed on top of the multipoint flow distributor; wherein the holes embedded in the multipoint flow distributor are served to allow the electrolyte having vanadium ions in different oxidation states to flow through the electrodes, and, by the electrochemical reaction of the vanadium ions in the electrolyte an electrical energy is generated and is output to the external load, or the external electrical energy is converted into chemical energy stored in the vanadium ions. The novel bipolar plate design of the present invention can be used in a vanadium redox flow battery. The problems of the above-mentioned conventional flow battery including the concentration of the polarization of the electrolyte are improved by using the novel bipolar plate design of the present invention. Meanwhile, in the present invention, the efficiency of electrochemical energy conversion is increased because the electrodes have a homogenous reaction area and the operating pressure of the electrolytes is reduced.

This is a power density improvement over the interdigital flow field type of FIG. 4 by a factor of about 2, and a power density improvement over the flow through type of FIG. 6 by a factor of about 6.

A further object of the present invention is to provide a flow battery that has low costs, is relatively simple to provide in practice and is safe in application.

### BRIEF DESCRIPTION OF THE DRAWINGS

Further characteristics and advantages of the invention will become better apparent from the description of a preferred but not exclusive embodiment of the flow battery according to the invention, illustrated by way of non limiting examples in the accompanying drawings, wherein:

FIG. 1 is a schematic view showing a conventional vanadium redox flow battery;

FIG. 2 is a schematic axonometric view of a flow battery stack according to the state of the art;

FIG. 3 is a schematic axonometric view of a conventional bipolar plate design of a flow through type, according to the state of the art;

FIG. 4 is a schematic axonometric view of a conventional electrode, of the interdigital type, according to the state of the art.

FIG. 5 is a schematic axonometric view of an additional bipolar plate design of the interdigital type, according to the state of the art;

FIG. 6 is a schematic axonometric view of an additional conventional electrode, of a flow through type, according to the state of the art.

FIG. 7 is a schematic axonometric view of bipolar plate design according to the present invention.

FIG. 8 is a schematic axonometric view of bipolar plate design according to the present invention.

FIG. 9 is a schematic axonometric view of an electrode working according to the present invention.

FIG. 10 is a schematic axonometric view of a flow battery stack according to the present invention.

FIG. 11 is a schematic sectional view taken transversely to the channels in the bipolar plate, showing both sides of the bipolar plate and the assembly of components.

FIG. 12 is a close-up view of the inlet portion of the bipolar plate, showing dead end inlet channels and parallel outlet channels, as well as the flow into the dead end channels.

### DETAILED DESCRIPTION OF THE INVENTION

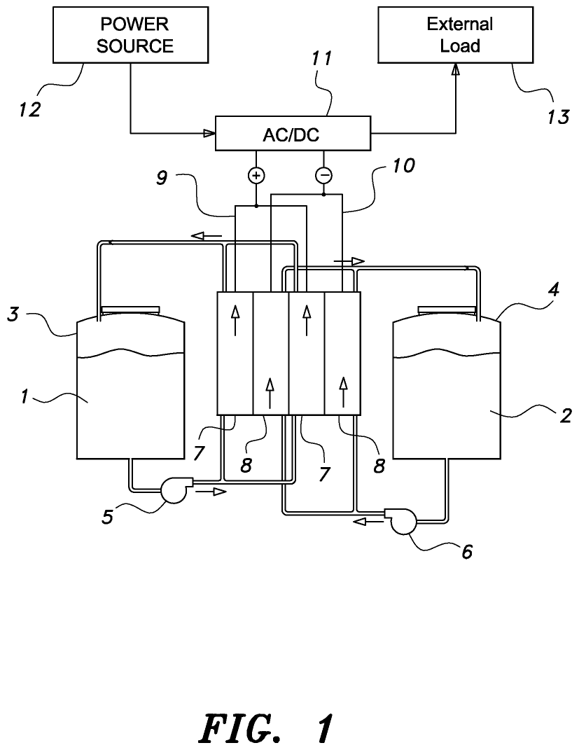

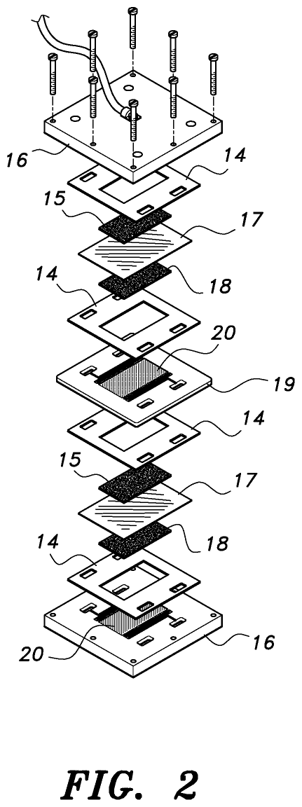

FIGS. 1-6 have been described above.

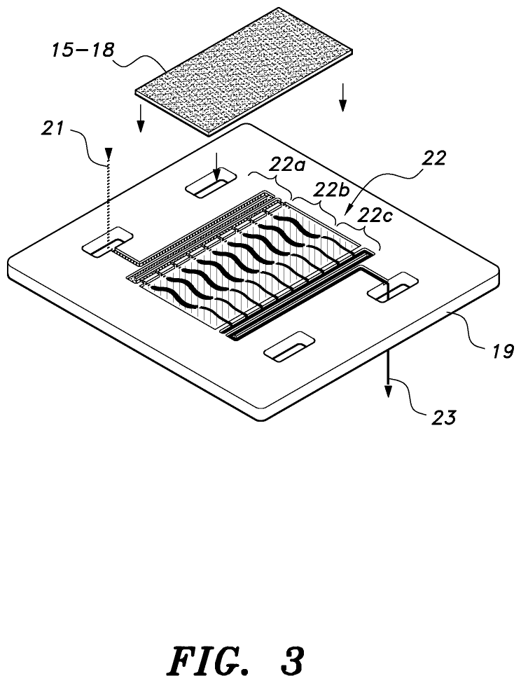

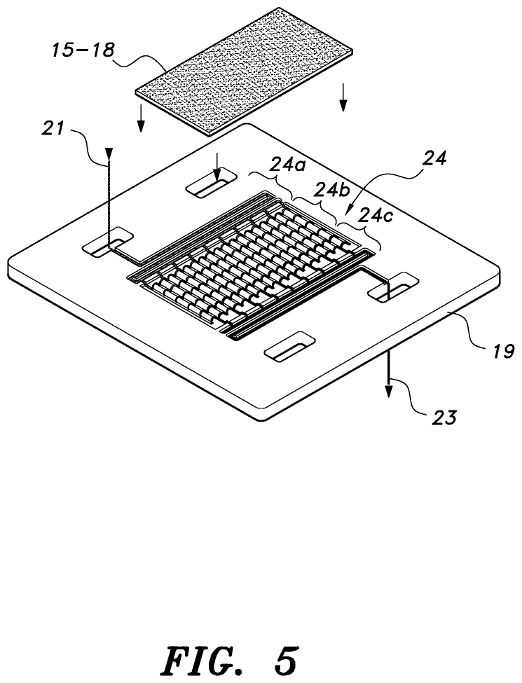

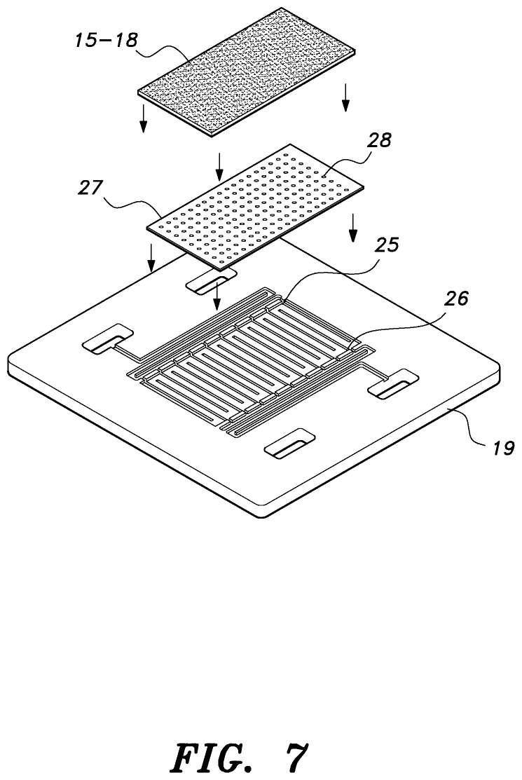

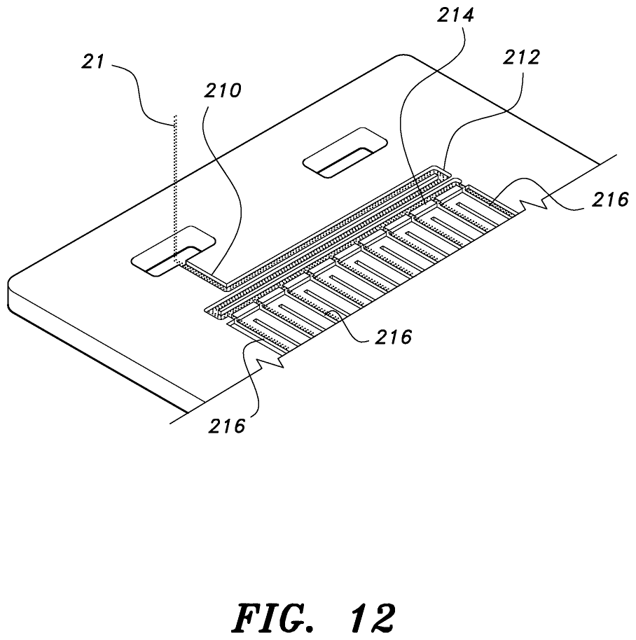

FIG. 7 is a schematic axonometric view of bipolar plate assembly having a bipolar plate 19 of the type described above with respect to FIGS. 3 and 5. The bipolar plate 19 of the present invention differs in that it has a plurality of parallel dead end inlet channels 25 (also referred to hereinafter as an inlet flow field), and a plurality of dead end outlet channels 26 (also referred to hereinafter as an outlet flow field) which are interdigitated with the inlet channels 25 as shown in FIG. 7. A close up of this arrangement is provided in FIG. 12, which clearly shows this.

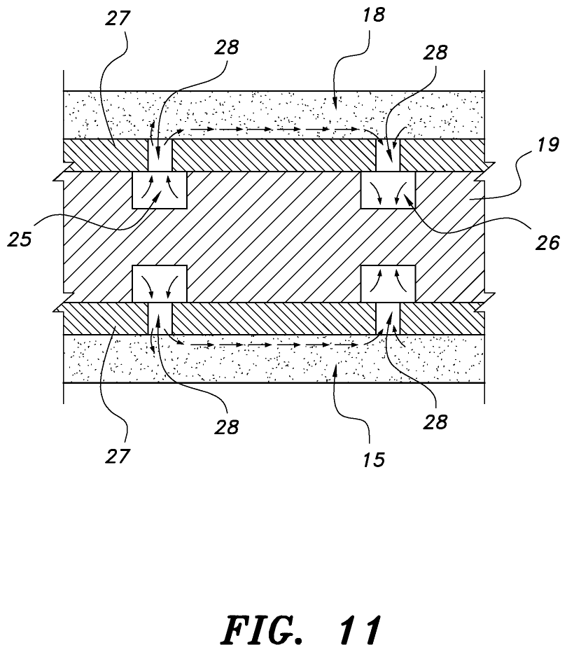

Specifically, FIG. 7 shows an innovative bipolar plate assembly for a vanadium redox flow battery, which includes the bipolar plate 19 having on its two mutually opposite faces respectively—as shown clearly in FIG. 11—an inlet dead end flow field 25, an outlet flow field 26, a multipoint flow distributor 27 having a plurality of holes 28. The holes 28 are at a relatively close spacing between them, e.g. 8 mm apart, and wherein the holes 28 are substantially uniformly distributed on the surface of the multipoint flow distributor 27. Only one side of the bipolar plate 19 is shown, the opposite side being identical (see FIG. 11) and therefore is not shown in FIG. 7

The multipoint flow distributor 27 is placed on top of the bipolar plate flow fields 25 and 26, such that the holes 28 are aligned to communicate respectively with the channels 25 and 26. A positive electrode 15 is disposed above the multipoint flow distributor 27 on one side of the bipolar plate 19, and a negative electrode 18 is disposed on the opposite side of the bipolar plate 19 respectively on the opposite surface of the respective multipoint flow distributor 27. See FIG. 12, which shows this.

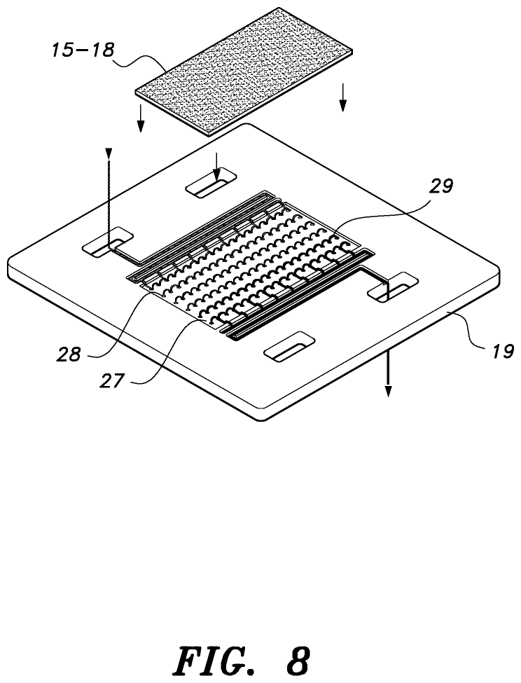

FIG. 8 is a schematic axonometric view of bipolar plate assembly showing an inlet fluid path, a transverse fluid flow, and an outlet fluid path. These are shown by different shadings for the sake of clarity, with the inlet flow having stippling, and the outlet flow being solid black. The transverse flow is show as semicircular loops, which is approximately how the actual fluid flow will appear; see FIG. 11 for a detailed view of the transverse fluid flow.

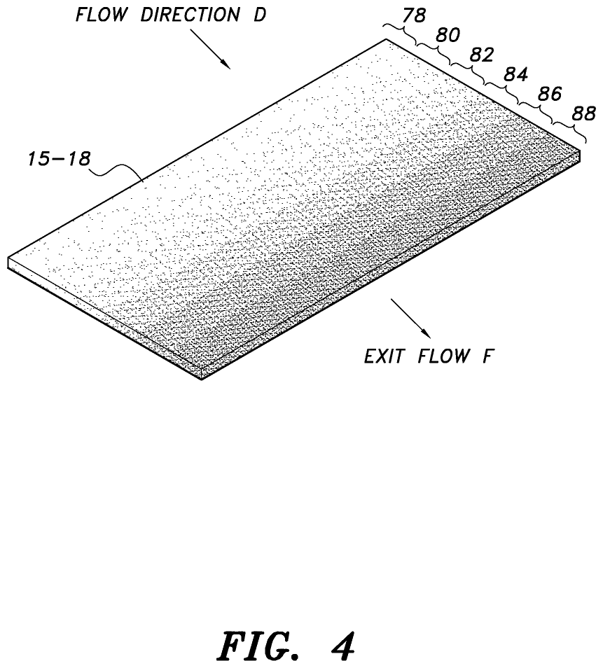

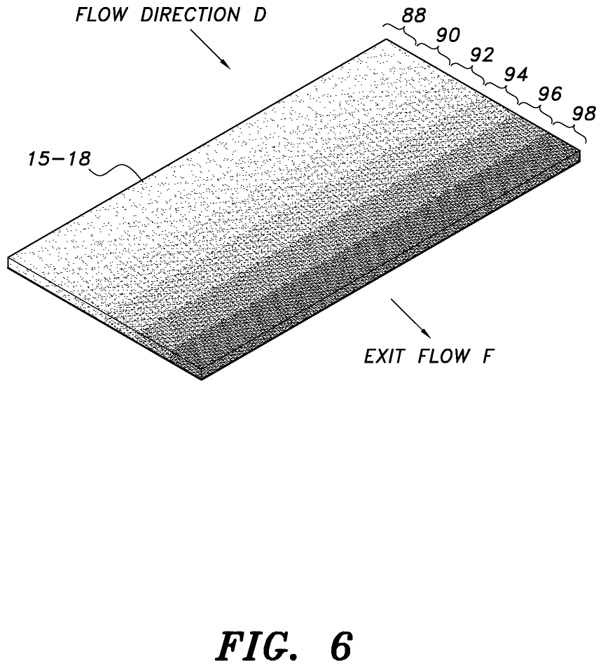

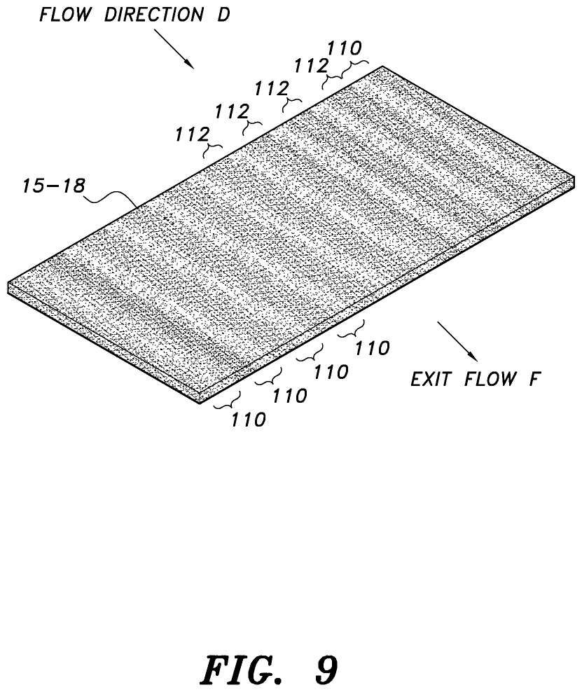

FIG. 9 is a schematic axonometric view of an electrode 15, 18 working in the arrangement shows in FIGS. 7 and 8, described above. The inlet flow direction is shown by an arrow labeled D, and the exit flow direction is shown by an arrow labeled F. Because of the transverse fluid flow discussed above with respect to FIG. 8, the bands of polarization run transversely to the direction of overall fluid flow, and are in light bands 110, interleaved with dark bands 112. The shading is much more uniformly distributed across the surface of the electrode 15, 18. This indicates that the entire surface of the electrode 15, 18 is being used, with less concentration of polarization, due to the bands 110 and 112 as compared with the bands in the previously described FIGS. 4 and 6.

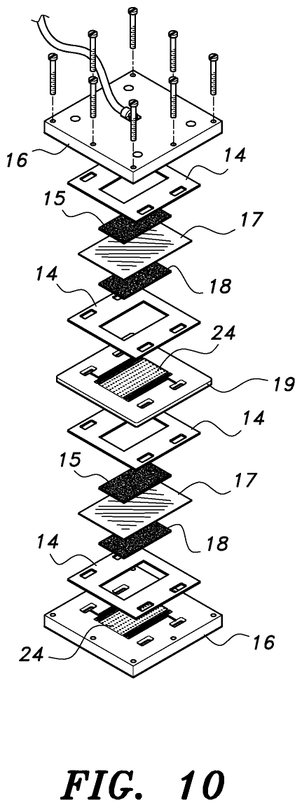

FIG. 10 is a schematic axonometric view of a flow battery stack according to the present invention. The flow battery stack has top and bottom plates 16 (which preferably are the same as the bipolar plate 19 in construction but having only one side being used), and these respectively contain an undefined number (i.e. an arbitrary selected number) of planar cells respectively constituted by a series of cathode electrodes 15, a series of proton exchange membranes 17, a series of bipolar plates 19 provided with the multipoint flow distributors 27 on the two mutually opposite faces (as shown in FIG. 11), a series of anode electrodes 18, a series of gaskets 14, all the above constitute a flow battery stack provided with corresponding pumps (not shown in FIG. 10) for the supply of electrolytes to specific planar cells, provided with multipoint flow distributors 27 on the two mutually opposite faces for the independent conveyance of the electrolytes, and wherein the cells are mutually separated by proton exchange membranes 17 and electrodes 15, 18.

The planar cells of the battery stack in the preferred embodiment are mutually aligned and stacked so as to constitute a laminar pack. The end plate 19 is arranged on at least one front of the laminar pack. The end plate 19 is provided with a pair of access channels on the inlet side, which are the large pair of openings (unnumbered) on the inlet side, and a pair of discharge openings on the exit side (unnumbered), providing an access for the electrolytes that arrive from the electrolyte tanks by means of two pumps (as shown in FIG. 1), and providing for the discharge outlet for the exiting electrolytes, and which are connected to the respective tanks of FIG. 1.

As described in FIG. 8 of the present invention, on the multipoint flow distributor 27, the electrolyte flow, comes out respectively by the feed holes 28 connected in correspondence of the inlet dead end flow field 25, wherein the electrolyte flows transversely, making a very short path, and falls respectively into the holes 28 which are connected to the outlet flow field 26.

As shown in FIG. 8, the multipoint flow distributor 27 has a plurality of holes 28 homogeneously distributed on the surface. These holes are placed at close distances from each other e.g. 8 mm, wherein the electrolyte flow 29 flows through that plurality of holes 28. These flow s are spread on the distributor surfaces, creating a plurality of electrolyte flows 29, as indicated by the arrows. As mentioned above, this plurality of flows 29 are evenly distributed on the surface, and the flows pass through transversely across the electrodes 15-18 placed on the flow distributor surface, and due to the short path between the inlet holes and the outlet holes the charge transfer to the electrolyte occurs locally in homogeneous conditions throughout the electrode surface.

This is a power density improvement over the interdigital flow field type of FIG. 4 by a factor of about 2, and a power density improvement over the flow through type of FIG. 6 by a factor of about 6.

As shown in FIG. 9 of the present invention, an electrode 15-18 in operation is represented, wherein the charge transfer to the electrolyte is indicated by the change of colors. The charge transfer is homogeneously distributed on all the electrode surface, meanwhile the electric current density is increased, the energy efficiency is improved, and the operating pressure is reduced.

Important features of the present invention are that a high efficiency bipolar plate design is obtained by assembling the bipolar plate and the multipoint flow distributor together, wherein in the graphite bipolar plate 19 the flow field channels are created to allow the electrolyte to flow to the distributor holes so that the problems of the homogeneous distribution and the concentration of polarization of the electrolyte can be decreased. Meanwhile, the reactivity of the electrode is increased by the combination of a plurality of holes at close distance to each other so that the charge transfer to the electrolyte flows becomes more efficient, the energy conversion is improved and the operating pressure is reduced. The design provided by the present invention can be applied not only to flow batteries, but to a variety of electrochemical devices such as e.g. the fuel cell, the electrolyzers, and all other electrochemical devices where flow distribution is critical.

FIG. 11 is a schematic sectional view taken transversely to the channels in the bipolar plate, showing both sides of the bipolar plate and the assembly of components. These have been described in the above.

FIG. 12 is a close-up view of the inlet portion of the bipolar plate, showing dead end inlet channels 25 and parallel outlet channels 26, as well as the flow (by use of arrows) into or out of the dead end channels 25, 26. This has been described above.

While the holes 28 in the multipoint flow distributor 27 are shown as being uniform in the preferred embodiment, the present invention is not limited to this. The holes can vary in size, shape, and location, and can be varied in those ways in order to control such variables as fluid flow, pressure along the flow path, temperature, and polarization, among others.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A flow battery of the type having a first tank for an anode electrolyte, a second tank for a cathode electrolyte, respective hydraulic circuits provided with corresponding pumps for supplying electrolytes to specific planar cells, the planar cells comprising: a bipolar plate body having two opposed faces, each of said opposed faces having a plurality of inlet dead end channels and a plurality of outlet dead end channels; a pair of multipoint flow distributors disposed on said two opposed faced such that each of said pair of multipoint flow distributors is in engagement with said inlet channels and said outlet channels, said multipoint flow distributor having passages allowing communication between said inlet channels and said outlet channels, for relatively homogenous conveyance of said electrolytes; said bipolar plates being mutually separated by respective one s of a plurality of proton exchange membranes and electrodes, wherein said planar cells are mutually aligned and stacked so as to constitute a flow battery stack.

2. The flow battery according to claim 1, wherein said inlet channels and said outlet channels are interdigitated.

3. The flow battery according to claim 1 wherein said multipoint flow distributor has surface, and has a plurality of holes being homogeneously spaced on said surface.

4. The flow battery according to claim 3 wherein a multipoint flow distributor is placed respectively on top of the bipolar plate flow fields aligning the holes to the inlet and outlet channels.

5. The flow battery according to claim 1 wherein a positive electrode and a negative electrode are placed on the surface of the multipoint flow distributor.

6. The flow battery according to claim 3 wherein the holes are arranged in a rectangular grid pattern.

7. The flow battery according to claim 3 wherein the multipoint flow distributor, having a plurality of holes evenly distributed on the surface as a spacing of approximately 8 mm, and wherein the electrolyte having vanadium ions in different oxidation states flows through the holes and transversely pass through the electrodes being disposed on the flow distributor surface, and by the electrochemical reactions of the vanadium ions an electrical energy is generated and selectively output to one of (a) a n external load and (b) is converted into chemical energy stored in the vanadium ions.
